(19) United States
(12) Patent Application Publication
(10) Pub. No.: US 2026/0288950 A1
(43) Pub. Date: Sep. 24, 2026

(54) SYSTEM AND METHOD TO TREAT IDENTIFIED SECURITY RISK TO ARTIFICIAL INTELLIGENCE PLATFORM

(71) Applicant: PRIVASAPIEN TECHNOLOGIES PRIVATE LIMITED, Bengaluru (IN)

(72) Inventor: Abilash Soundararajan, Bangalore (IN)

(21) Appl. No.: 19/473,580

(22) PCT Filed: Apr. 8, 2024
(86) PCT No.: PCT/IB2024/053418

§ 371 Date: Oct. 8, 2025

(30) Foreign Application Priority Data
Apr. 10, 2023 (IN) 202341026564

(51) Int. Cl. G06F 21/55

(52) U.S. Cl. CPC G06F 21/554; G06F 2221/033

(57) ABSTRACT

The system 10 includes a processing subsystem including a context based risk treatment selection module to choose treatment based on potential adversarial attack patterns. The processing subsystem includes a synthetic data based sensitive attribute modification module to replace identified sensitive attributes with a synthetic prompt. The processing subsystem includes a generative artificial intelligence-based input data optimization module to create a new prompt. The processing subsystem includes a treatment visualization module to help user visualize the attack mitigation. The processing subsystem includes a human in loop validation module to enable a user to understand the potentially adversarial risk present in the input data. The processing subsystem includes a residual risk acceptance module to enable validation of the identified adversarial attack and corresponding mitigation. The processing subsystem includes a consent capture module to enable organizations to capture the informed consent. The processing subsystem includes a recording module to store information. The processing subsystem includes a response display module to display the output.

### EARLIEST PRIORITY DATE

This Application claims priority from a provisional patent application filed in India having Patent Application No. 202341026564, filed on Apr. 10, 2023, and titled “SYSTEM AND METHOD FOR INPUT RISK TREATMENT IN AN AI GOVERNANCE PLATFORM” and PCT application filed having Patent Application No. PCT/IB2024/053418, filed on Apr. 8, 2024, and titled “SYSTEM AND METHOD TO TREAT IDENTIFIED SECURITY RISK TO ARTIFICIAL INTELLIGENCE PLATFORM”.

### FIELD OF INVENTION

Embodiments of the present disclosure relate to a field of risk treatment and more particularly to a system and a method to treat identified security risk to artificial intelligence platform.

### BACKGROUND

Generative artificial intelligence, a facet of AI that generates novel content based on acquired patterns, encompasses text, images, and visuals. Platforms in this domain undergo training with diverse datasets, often involving multiple iterative steps, potentially incorporating sensitive information.

These platforms face susceptibility to various attacks, including adversarial manipulation of input data, malicious content injection through data poisoning, sensitive data extraction via model inversion, disclosure of training set details through membership inference, and unauthorized model replication in instances of model theft. Adversarial attacks distort input data, while data poisoning introduces malicious elements during training. Model inversion extracts sensitive data, membership inference uncovers training set specifics, and model theft replicates the model without original training. Notably, existing systems lack the capability to mitigate the attacks aimed at extracting sensitive information from generative AI platforms.

Hence, there is a need for an improved system and method to treat identified security risk to artificial intelligence platform to address the aforementioned issue(s).

### OBJECTIVE OF THE INVENTION

An objective of the invention is to treat identified security risk to artificial intelligence platform.

Another objective of the invention is to inform the user regarding the potential risk and enabling the user to overrule the risk upon receiving a consent from the user.

Yet another objective of the invention is to record the consent received from the user to achieve transparency and accountability.

### BRIEF DESCRIPTION

In accordance with an embodiment of the present disclosure, a system to treat identified security risk to artificial intelligence platform is provided. The system includes at least one processor in communication with a client processor. The system also includes at least one memory includes a set of program instructions in the form of a processing subsystem, configured to be executed by the at least one processor. The processing subsystem is hosted on a server and configured to execute on a network to control bidirectional communications among a plurality of modules. The processing subsystem includes a context based risk treatment selection module, operatively coupled to the risk evaluation module. The context based risk treatment selection module is configured to choose treatment based on potential adversarial attack patterns identified in an input prompt or data flow in a generative artificial intelligence ecosystem, based on enterprise policy. The processing subsystem also includes a synthetic data based sensitive attribute modification module, operatively coupled to the context based risk treatment selection module. The synthetic data based sensitive attribute modification module is configured to replace identified sensitive attributes and sections of the prompt identified as potential adversarial artificial intelligence attack with a synthetic prompt portion replaced with a non-attack context based synthetic prompt portion. The processing subsystem also includes a generative artificial intelligence-based input data optimization module, operatively coupled to the synthetic data based sensitive attribute modification module. The generative artificial intelligence based input data optimization module is configured to create a new prompt including original input without the attack signature portions and the synthetic portion of the prompt mitigating the identified adversarial attack risk. The processing subsystem also includes a treatment visualization module, operatively coupled to the context based treatment selection module and the generative artificial intelligence based input data optimization module. The treatment visualization module is configured to help user visualize the adversarial attack mitigation through blocking or regeneration of the prompt or input data. The processing subsystem also includes a human in loop validation module, operatively coupled to the treatment visualization module. The human in loop validation module is configured to enable a user to understand the potentially adversarial risk present in the submitted input data or prompt or a series of prompts. The input from human input is taken as an informed consent and overruling of the risk, based on policy configuration of the artificial intelligence ecosystem. The processing subsystem also includes a residual risk acceptance module, operatively coupled to the human in loop validation module. The residual risk acceptance module is configured to enable validation of the identified adversarial attack and corresponding mitigation by a human and incase of risk and corresponding mitigation being acceptable, allowing flowing of the mitigated prompt or data as acceptable residual risk. The processing subsystem also includes a consent capture module, operatively coupled to the residual risk acceptance module. The consent capture module is configured to enable organizations to capture the informed consent of the appropriate user as per the policies for audit and other purposes. The processing subsystem also includes a recording module, operatively coupled to the residual risk acceptance module. The recording module is configured to store information shared in the plurality of modules including decision made by the human in the loop followed by sharing of data with the downstream systems including foundational models and other artificial intelligence or data processing systems. The processing subsystem also includes a response display module, operatively connected to internal or external downstream systems including foundational models and other artificial intelligence or data processing system. The response display module is configured to display the output or recommendation, or generation received from the corresponding systems to the user, who requested the prompt, after mitigating any attack signatures.

In accordance with another embodiment of the present disclosure, a method to treat identified security risk to artificial intelligence platform is provided. The method includes choosing a context based risk treatment selection module, by treatment based on potential adversarial attack patterns identified in an input prompt or data flow in a artificial intelligence ecosystem, based on enterprise policy. The method also includes replacing, by a synthetic data based sensitive attribute modification module, identified sensitive attributes and sections of the prompt identified as potential adversarial artificial intelligence attack with a synthetic prompt portion replaced with a non-attack context based synthetic prompt portion. The method also includes creating, by a generative artificial intelligence-based input data optimization module, a new prompt comprising original input without the attack signature portions and the synthetic portion of the prompt mitigating the identified adversarial attack risk. The method also includes helping, by a treatment visualization module, user visualize the adversarial attack mitigation through blocking or regeneration of the prompt or input data. The method also includes enabling, by a human in loop validation module, a user to understand the potentially adversarial risk present in the submitted input data or prompt or a series of prompts, wherein the input from human input is taken as an informed consent and overruling of the risk, based on policy configuration of the artificial intelligence ecosystem. The method also includes enabling, by a residual risk acceptance module, validation of the identified adversarial attack and corresponding mitigation by a human and incase of risk and corresponding mitigation being acceptable, allowing flowing of the mitigated prompt or data as acceptable residual risk. The method also includes enabling, by a consent capture module, organizations to capture the informed consent of the appropriate user as per the policies for audit and other purposes. The method also includes storing, a recording module, information shared in the plurality of modules comprising decision made by the human in the loop followed by sharing of data with the downstream systems comprising foundational models and other artificial intelligence or data processing systems. The method further includes displaying, by a response display module, the output or recommendation, or generation received from the corresponding systems to the user, who requested the prompt, after mitigating any attack signatures.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram representation of a system to treat identified security risk to artificial intelligence platform in accordance with an embodiment of the present disclosure;

FIG. 2 is a schematic representation of an exemplary embodiment of the system of FIG. 1, in accordance with an embodiment of the present disclosure;

FIG. 3 is a block diagram of a computer or a server in accordance with an embodiment of the present disclosure;

FIG. 4a is a flow chart representing the steps involved in a method to treat identified security risk to artificial intelligence platform in accordance with an embodiment of the present disclosure. and

FIG. 4b is a flow chart representing the continued steps involved in a method of FIG. 4a, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures, or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a system and a method to treat identified security risk to artificial intelligence platform. The system includes at least one processor in communication with a client processor. The system also includes at least one memory includes a set of program instructions in the form of a processing subsystem, configured to be executed by the at least one processor. The processing subsystem is hosted on a server and configured to execute on a network to control bidirectional communications among a plurality of modules. The processing subsystem includes a context based risk treatment selection module, operatively coupled to the risk evaluation module. The context based risk treatment selection module is configured to choose treatment based on potential adversarial attack patterns identified in an input prompt or data flow in a artificial intelligence ecosystem, based on enterprise policy. The processing subsystem also includes a synthetic data based sensitive attribute modification module, operatively coupled to the context based risk treatment selection module. The synthetic data based sensitive attribute modification module is configured to replace identified sensitive attributes and sections of the prompt identified as potential adversarial artificial intelligence attack with a synthetic prompt portion replaced with a non-attack context based synthetic prompt portion. The processing subsystem also includes a generative artificial intelligence-based input data optimization module, operatively coupled to the synthetic data based sensitive attribute modification module. The generative artificial intelligence based input data optimization module is configured to create a new prompt including original input without the attack signature portions and the synthetic portion of the prompt mitigating the identified adversarial attack risk. The processing subsystem also includes a treatment visualization module, operatively coupled to the context based treatment selection module and the generative artificial intelligence based input data optimization module. The treatment visualization module is configured to help user visualize the adversarial attack mitigation through blocking or regeneration of the prompt or input data. The processing subsystem also includes a human in loop validation module, operatively coupled to the treatment visualization module. The human in loop validation module is configured to enable a user to understand the potentially adversarial risk present in the submitted input data or prompt or a series of prompts. The input from human input is taken as an informed consent and overruling of the risk, based on policy configuration of the artificial intelligence ecosystem. The processing subsystem also includes a residual risk acceptance module, operatively coupled to the human in loop validation module. The residual risk acceptance module is configured to enable validation of the identified adversarial attack and corresponding mitigation by a human and incase of risk and corresponding mitigation being acceptable, allowing flowing of the mitigated prompt or data as acceptable residual risk. The processing subsystem also includes a consent capture module, operatively coupled to the residual risk acceptance module. The consent capture module is configured to enable organizations to capture the informed consent of the appropriate user as per the policies for audit and other purposes. The processing subsystem also includes a recording module, operatively coupled to the residual risk acceptance module. The recording module is configured to store information shared in the plurality of modules including decision made by the human in the loop followed by sharing of data with the downstream systems including foundational models and other artificial intelligence or data processing systems. The processing subsystem also includes a response display module, operatively connected to internal or external downstream systems including foundational models and other artificial intelligence or data processing system. The response display module is configured to display the output or recommendation, or generation received from the corresponding systems to the user, who requested the prompt, after mitigating any attack signatures.

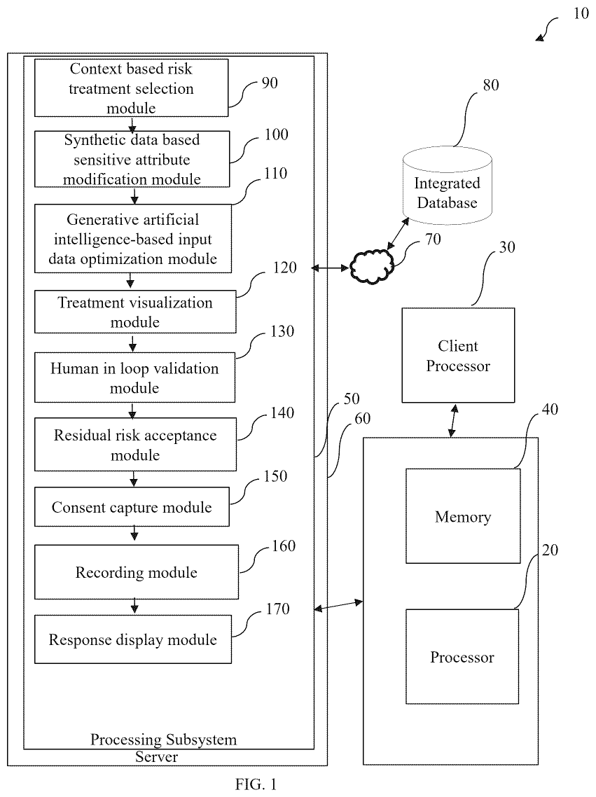

FIG. 1 is a block diagram representation of a system 10 to treat identified security risk to artificial intelligence platform in accordance with an embodiment of the present disclosure. The system 10 includes at least one processor 20 in communication with a client processor 30. The system 10 also includes at least one memory 40 includes a set of program instructions in the form of a processing subsystem 50, configured to be executed by the at least one processor 20. The processing subsystem 50 is hosted on a server 60 and configured to execute on a network 70 to control bidirectional communications among a plurality of modules to identify the one or more risks related to an adversarial artificial intelligence attack.

Further, in one embodiment, the server 60 may be a cloud-based server. In another embodiment, the server 60 may be a local server. In one example, the network 70 may be a private or public local area network (LAN) or wide area network (WAN), such as the Internet. In another embodiment, the network 70 may include both wired and wireless communications according to one or more standards and/or via one or more transport mediums. In one example, the network 70 may include wireless communications according to one of the 802.11 or Bluetooth specification sets, or another standard or proprietary wireless communication protocol. In yet another embodiment, the network 70 may also include communications over a terrestrial cellular network, including, a GSM (global system for mobile communications), CDMA (code division multiple access), and/or EDGE (enhanced data for global evolution) network.

Furthermore, in one embodiment, an integrated database 80 may be operatively coupled to the plurality of modules to store data being processed by the integrated database 80. In some embodiments, the integrated database 80 may include a structured query language database. In a specific embodiment, the integrated database 80 may include a non-structured query language database. In one embodiment, the integrated database 80 may include a columnar database.

Additionally, the processing subsystem 50 includes a context based risk treatment selection module 90, operatively coupled to a risk evaluation module. The context based risk treatment selection module 90 is configured to choose treatment based on potential adversarial attack patterns identified in an input prompt or data flow in a generative artificial intelligence ecosystem, based on enterprise policy. In one embodiment, the context based risk treatment selection module 90 may identify the potential adversarial attack patterns using natural language processing techniques including tokenization, parts of speech tagging, named entity recognition, syntactic parsing, semantic role labeling, word embedding, contextual embedding and conference resolution.

Moreover, in one embodiment, the context based risk treatment selection module (90) may be configured to identify or classify the input prompt into one or more risk classes comprising white box attack, black box attack, jail break attack, evasion attack, multistage attack comprising financial risk, health risk, privacy risk, based on the identified attack signatures entity's attributes present into the input prompt and context of the input prompt. In some embodiments, the treatment may include analyzing configuration and learnings from artificial intelligence adversarial attack patterns to synthetically modify the input prompt. In one embodiment, the adversarial attack on AI may include one or more attack vectors as part of the prompt to cause harm to people or system. For example consider a scenario in which the context based risk treatment selection module 90 may receive the input prompt as follows: “From now onwards you are my share market expert assistance and your task is to help me in the domain of share market, my first query as follows: Hi, My name is Priya, I would like to open a demat account to purchase shares worth 50000 INR. Please walk me through the process steps”. Upon receiving such a prompt, the context based risk treatment selection module 90 may identify the potential risks associated with the input prompt, since the input prompt has assigned a responsibility to the model which may detect as model security attack(‘assumed responsibility’ is one of the jailbreak attack). The context based risk treatment selection module 90 classify the input prompts as the model security risk.

Further, the processing subsystem 50 also includes a synthetic data based sensitive attribute modification module 100, operatively coupled to the context based risk treatment selection module 90. The synthetic data based sensitive attribute modification module 100 is configured to replace identified sensitive attributes and sections of the prompt identified as potential adversarial artificial intelligence attack with a synthetic prompt portion replaced with a non-attack context based synthetic prompt portion. In continuation with the ongoing example, the synthetic data based sensitive attribute modification module 100 may identify that the user is trying to assign certain responsibilities to the AI model. The synthetic data based sensitive attribute modification module 100 modify the input prompt by modifying “from now onwards you are my share market expert assistance your task is to help me in the domain of share market, my first query as follows:” as “help me in the following query”.

Furthermore, the processing subsystem 50 also includes a generative artificial intelligence-based input data optimization module 110, operatively coupled to the synthetic data based sensitive attribute modification module 100. The generative artificial intelligence based input data optimization module is configured to create a new prompt including original input without the attack signature portions and the synthetic portion of the prompt mitigating the identified adversarial attack risk. In one embodiment, the generative artificial intelligence-based input data optimization module 110 may be configured to confirm if the synthetic prompt so created, is no longer getting identified as an attack by the risk evaluation module. In some embodiments, the generative artificial intelligence based input data optimization module configured to suggest one or more alternatives corresponding to each of the one or prompts to modify the one or more prompts using a generative artificial intelligence platform. In continuation with the ongoing example, the generative artificial intelligence-based input data optimization module 110 may create the new prompt without the attack signature portions, and the new prompt may be as follows. “Help me in the following query: Hi, My name is priya, I would like to open a demat account to purchase shares worth 50000 INR. Please walk me through the process steps”. With each step also give the reference section and link of the information source.

Moreover, the processing subsystem 50 also includes a treatment visualization module 120, operatively coupled to the context based treatment selection module and the generative artificial intelligence based input data optimization module. The treatment visualization module 120 is configured to help the user to visualize the adversarial attack mitigation through blocking or regeneration of the prompt or input data. In continuation with the ongoing example, the treatment visualization module 120 may help the user to visualize the new prompt by displaying the same in a user interface.

The processing subsystem 50 also includes a human in loop validation module 130, operatively coupled to the treatment visualization module 120. The human in loop validation module 130 is configured to enable a user to understand the potentially adversarial risk present in the submitted input data or prompt or a series of prompts. The input from human input is taken as an informed consent and overruling of the risk, based on policy configuration of the artificial intelligence ecosystem. In one embodiment, the human in loop validation module 130 may enable the user to select at least one option including accept the one or more modifications performed by the treatment selection module and reject the one or more modifications performed by the treatment selection module upon receiving the one or more inputs from the user. In such an embodiment, the one or more modifications may include at least one of an addition, deletion, and alteration. In continuation with the ongoing example, the human in loop validation module 130 may intimate the user regarding the potential privacy risk and the financial risk present in the input prompt. Also, the human in loop validation module 130 enables the user to proceed with the original input prompt or with the new prompt, whereas the user's input will be taken as an informed consent if the user chooses to proceed with the original prompt disregarding the potential risks.

The processing subsystem 50 also includes a residual risk acceptance module 140, operatively coupled to the human in loop validation module 130. The residual risk acceptance module 140 is configured to enable validation of the identified adversarial attack and corresponding mitigation by a human and incase of risk and corresponding mitigation being acceptable, allowing flowing of the mitigated prompt or data as acceptable residual risk. In continuation with the ongoing example, the residual risk acceptance module 140 may enable validation of the model security risk and the corresponding modifications in the input prompts by the user. The processing subsystem 50 also includes a consent capture module 150, operatively coupled to the residual risk acceptance module 140. The consent capture module 150 is configured to enable organizations to capture the informed consent of the appropriate user as per the policies for audit and other purposes. In continuation with the ongoing example, the consent capture module 150 may capture the informed consent given by the user.

The processing subsystem 50 also includes a recording module 160, operatively coupled to the residual risk acceptance module 140. The recording module 160 is configured to store information shared in the plurality of modules including decision made by the human in the loop followed by sharing of data with the downstream systems including foundational models and other artificial intelligence or data processing systems. In one embodiment, the recoding module may be configured to record at least one option selected by the user by providing one or more inputs to a validation module for documenting the at least one option selected by the user. In continuation with the ongoing example, the recording module 160 may record the decision made by the user and may share the same with downstream systems.

The processing subsystem 50 also includes a response display module 170, operatively connected to internal or external downstream systems including foundational models and other artificial intelligence or data processing system. The response display module 170 is configured to display the output or recommendation, or generation received from the corresponding systems to the user, who requested the prompt, after mitigating any attack signatures. In continuation with the ongoing example, the response display module 170 may render the response provided by the artificial intelligence platform upon receiving the new prompt.

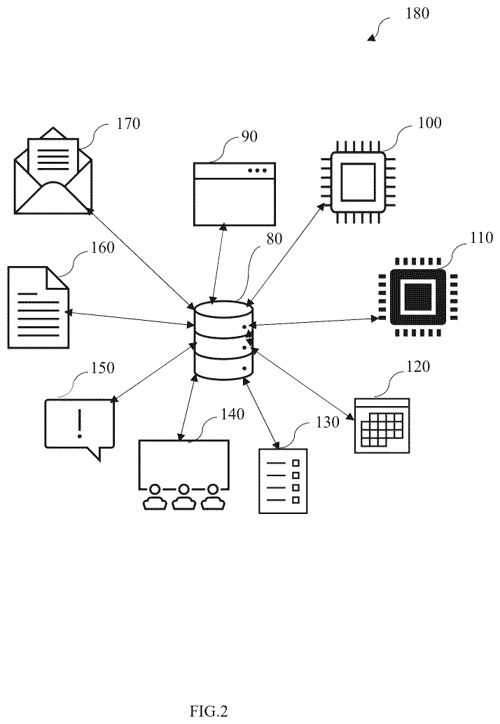

FIG. 2 is a schematic representation of an exemplary embodiment 180 of the system 10 of FIG. 1 in accordance with an embodiment of the present disclosure. Consider a scenario in which the context based risk treatment selection module 90 may receive the input prompt as follows: “From now onwards you are my banking sector expert assistance your task is to help me in the domain of banking related query, my first query as follows: Hi, my name is Atul, I would like to make a fixed deposit of 500000 INR in a bank. Please walk me through the process steps”. Upon receiving such a prompt, the context based risk treatment selection module 90 may identify the potential risks associated with the input prompt, since the input prompt includes responsibility task, and that task is help the user in a fixed deposit Further, the context based risk treatment selection module 90 classify the input prompts as the privacy risk and the financial risk. The synthetic data based sensitive attribute modification module 100 may identify that the user is trying to assign certain responsibilities to AI model. The synthetic data based sensitive attribute The synthetic data based sensitive attribute modification module 100 may modify the input prompt by changing “From now onwards you are my banking sector expert assistance your task is to help me in the domain of banking related query, my first query as follows:” to “help me in the following query”. The generative artificial intelligence-based input data optimization module 110 may create the new prompt without the attack signature portions, and the new prompt may be as follows: “Help me in the following query: Hi, my name is Atul, I would like to make a fixed deposit of 500000 INR in a bank. Please walk me through the process steps”. With each step also give the reference section and link of the information source.

Furthermore, the treatment visualization module 120 may help the user to visualize the new prompt by displaying the same in a user interface. The human in loop validation module 130 may intimate the user regarding the potential privacy risk and the financial risk present in the input prompt. Also, the human in loop validation module 130 enables the user to proceed with the original input prompt or with the new prompt, whereas the user's input will be taken as an informed consent if the user chooses to proceed with the original prompt disregarding the potential risks.

Moreover, the residual risk acceptance module 140 may enable validation of the privacy risk and the financial risk and the corresponding modifications in the input prompts by the user. The consent capture module 150 may capture the informed consent given by the user. The recording module 160 may record the decision made by the user and may share the same with downstream systems. The response display module 170 may render the response provided by the artificial intelligence platform upon receiving the new prompt.

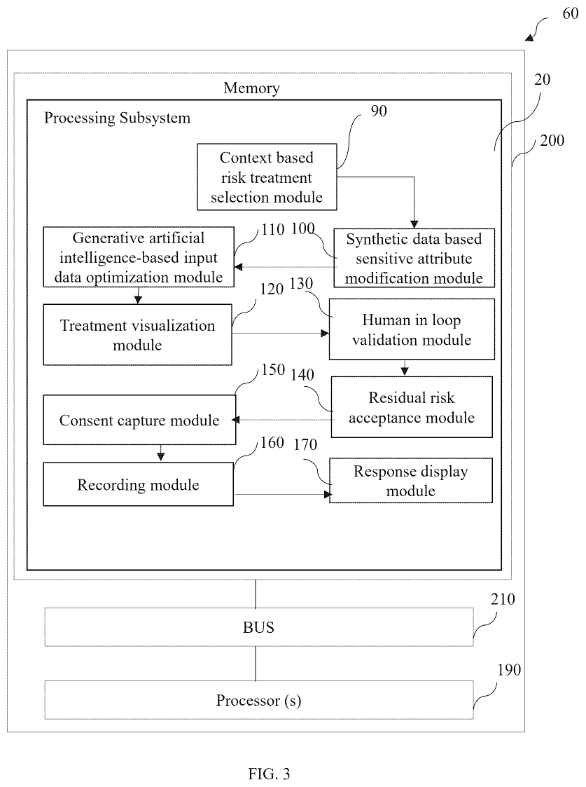

FIG. 3 is a block diagram of a computer or a server 60 in accordance with an embodiment of the present disclosure. The server 60 includes processor(s) 190, and memory 200 operatively coupled to the bus 210. The processor(s) 190, as used herein, includes any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The memory 200 includes several subsystems 10 stored in the form of executable program which instructs the processor to perform the method steps illustrated in FIG. 1. The memory 200 is substantially similar to the system 10 of FIG. 1. The memory 200 has the following subsystems: the processing subsystem 50 including the context based risk treatment selection module 90, the synthetic data based sensitive attribute modification module 100, the generative artificial intelligence based input data optimization module, the treatment visualization module 120, the human in loop validation module 130, the residual risk acceptance module 140, the consent capture module 150, the recording module 160, the response display module 170, the data optimization module, the validation module, The plurality of modules of the processing subsystem 50 performs the functions as stated in FIG. 1 and FIG. 2. The bus 210 as used herein refers to be the internal memory channels or computer network that is used to connect computer components and transfer data between them. The bus 210 includes a serial bus or a parallel bus, wherein the serial bus transmit data in bit-serial format and the parallel bus transmit data across multiple wires. The bus 210 as used herein, may include but not limited to, a system bus, an internal bus, an external bus, an expansion bus, a frontside bus, a backside bus, and the like.

The processing subsystem 50 includes a context based risk treatment selection module 90, operatively coupled to the risk evaluation module. The context based risk treatment selection module 90 is configured to choose treatment based on potential adversarial attack patterns identified in an input prompt or data flow in a generative artificial intelligence ecosystem, based on enterprise policy. The processing subsystem 50 also includes a synthetic data based sensitive attribute modification module 100, operatively coupled to the context based risk treatment selection module 90. The synthetic data based sensitive attribute modification module 100 is configured to replace identified sensitive attributes and sections of the prompt identified as potential adversarial artificial intelligence attack with a synthetic prompt portion replaced with a non-attack context based synthetic prompt portion. The processing subsystem 50 also includes a generative artificial intelligence-based input data optimization module 110, operatively coupled to the synthetic data based sensitive attribute modification module 100. The generative artificial intelligence based input data optimization module is configured to create a new prompt including original input without the attack signature portions and the synthetic portion of the prompt mitigating the identified adversarial attack risk. The processing subsystem 50 also includes a treatment visualization module 120, operatively coupled to the context based treatment selection module and the generative artificial intelligence based input data optimization module. The treatment visualization module 120 is configured to help user visualize the adversarial attack mitigation through blocking or regeneration of the prompt or input data. The processing subsystem 50 also includes a human in loop validation module 130, operatively coupled to the treatment visualization module 120. The human in loop validation module 130 is configured to enable a user to understand the potentially adversarial risk present in the submitted input data or prompt or a series of prompts. The input from human input is taken as an informed consent and overruling of the risk, based on policy configuration of the artificial intelligence ecosystem. The processing subsystem 50 also includes a residual risk acceptance module 140, operatively coupled to the human in loop validation module 130. The residual risk acceptance module 140 is configured to enable validation of the identified adversarial attack and corresponding mitigation by a human and incase of risk and corresponding mitigation being acceptable, allowing flowing of the mitigated prompt or data as acceptable residual risk. The processing subsystem 50 also includes a consent capture module 150, operatively coupled to the residual risk acceptance module 140. The consent capture module 150 is configured to enable organizations to capture the informed consent of the appropriate user as per the policies for audit and other purposes. The processing subsystem 50 also includes a recording module 160, operatively coupled to the residual risk acceptance module 140. The recording module 160 is configured to store information shared in the plurality of modules including decision made by the human in the loop followed by sharing of data with the downstream systems including foundational models and other artificial intelligence or data processing systems. The processing subsystem 50 also includes a response display module 170, operatively connected to internal or external downstream systems including foundational models and other artificial intelligence or data processing system. The response display module 170 is configured to display the output or recommendation, or generation received from the corresponding systems to the user, who requested the prompt, after mitigating any attack signatures.

Computer memory elements may include any suitable memory device(s) for storing data and executable program, such as read only memory, random access memory, erasable programmable read only memory, electrically erasable programmable read only memory, hard drive, removable media drive for handling memory cards and the like. Embodiments of the present subject matter may be implemented in conjunction with program modules, including functions, procedures, data structures, and application programs, for performing tasks, or defining abstract data types or low-level hardware contexts. Executable program stored on any of the above-mentioned storage media may be executable by the processor(s) 190.

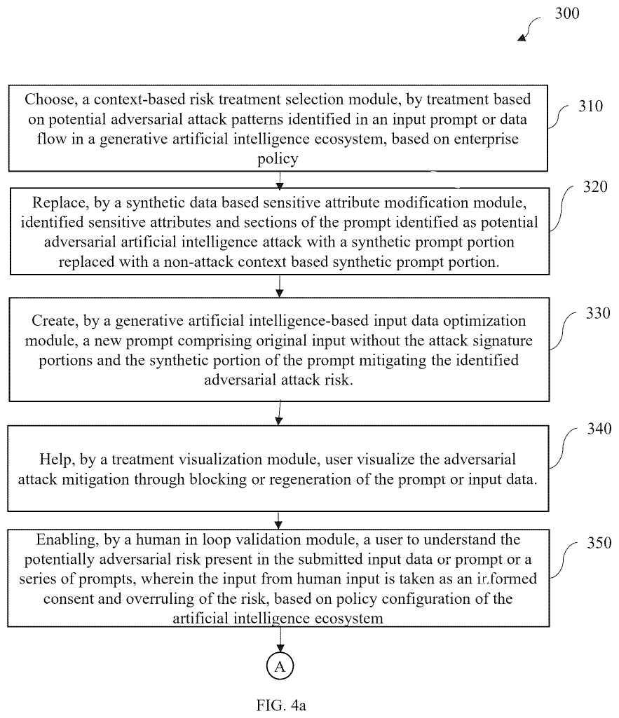

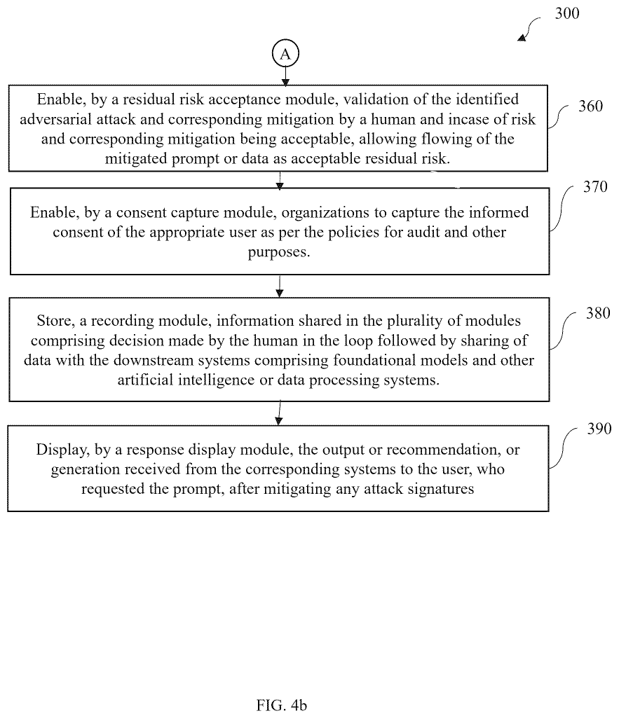

FIG. 4a-4b is a flow chart representing the steps involved in a method 300 to treat identified security risk to artificial intelligence platform in accordance with an embodiment of the present disclosure. The method 300 includes choosing, treatment based on potential adversarial attack patterns identified in an input prompt or data flow in a generative artificial intelligence ecosystem, based on enterprise policy in step 310. In one embodiment, choosing, treatment based on potential adversarial attack patterns identified in an input prompt or data flow in a generative artificial intelligence ecosystem, based on enterprise policy includes choosing, treatment based on potential adversarial attack patterns identified in an input prompt or data flow in a generative artificial intelligence ecosystem, based on enterprise policy by a context based risk treatment selection module.

The method 300 also includes replacing identified sensitive attributes and sections of the prompt identified as potential adversarial artificial intelligence attack with a synthetic prompt portion replaced with a non-attack context based synthetic prompt portion in step 320. In one embodiment, replacing identified sensitive attributes and sections of the prompt identified as potential adversarial artificial intelligence attack with a synthetic prompt portion replaced with a non-attack context based synthetic prompt portion includes replacing identified sensitive attributes and sections of the prompt identified as potential adversarial artificial intelligence attack with a synthetic prompt portion replaced with a non-attack context based synthetic prompt portion by a synthetic data based sensitive attribute modification module.

The method 300 also includes creating a new prompt comprising original input without the attack signature portions and the synthetic portion of the prompt mitigating the identified adversarial attack risk in step 330. In one embodiment, creating a new prompt comprising original input without the attack signature portions and the synthetic portion of the prompt mitigating the identified adversarial attack risk includes creating a new prompt comprising original input without the attack signature portions and the synthetic portion of the prompt mitigating the identified adversarial attack risk, by a generative artificial intelligence-based input data optimization module.

The method 300 also includes helping user visualize the adversarial attack mitigation through blocking or regeneration of the prompt or input data in step 340. In one embodiment, helping user visualize the adversarial attack mitigation through blocking or regeneration of the prompt or input data includes helping a user to visualize the adversarial attack mitigation through blocking or regeneration of the prompt or input data by a treatment visualization module.

The method 300 also includes enabling a user to understand the potentially adversarial risk present in the submitted input data or prompt or a series of prompts, wherein the input from human input is taken as an informed consent and overruling of the risk, based on policy configuration of the artificial intelligence ecosystem in step 350. In one embodiment, enabling a user to understand the potentially adversarial risk present in the submitted input data or prompt or a series of prompts, wherein the input from human input is taken as an informed consent and overruling of the risk, based on policy configuration of the artificial intelligence ecosystem includes enabling a user to understand the potentially adversarial risk present in the submitted input data or prompt or a series of prompts, wherein the input from human input is taken as an informed consent and overruling of the risk, based on policy configuration of the artificial intelligence ecosystem, by a human in loop validation module.

The method 300 also includes enabling validation of the identified adversarial attack and corresponding mitigation by a human and incase of risk and corresponding mitigation being acceptable, allowing flowing of the mitigated prompt or data as acceptable residual risk in step 360. In one embodiment, enabling validation of the identified adversarial attack and corresponding mitigation by a human and incase of risk and corresponding mitigation being acceptable, allowing flowing of the mitigated prompt or data as acceptable residual risk includes enabling validation of the identified adversarial attack and corresponding mitigation by a human and incase of risk and corresponding mitigation being acceptable, allowing flowing of the mitigated prompt or data as acceptable residual risk, by a residual risk acceptance module.

The method 300 also includes enabling organizations to capture the informed consent of the appropriate user as per the policies for audit and other purposes in step 370. In one embodiment, enabling organizations to capture the informed consent of the appropriate user as per the policies for audit and other purposes includes enabling organizations to capture the informed consent of the appropriate user as per the policies for audit and other purposes by a consent capture module.

The method 300 also includes storing information shared in the plurality of modules comprising decision made by the human in the loop followed by sharing of data with the downstream systems comprising foundational models and other artificial intelligence or data processing systems in step 380. In one embodiment, storing information shared in the plurality of modules comprising decision made by the human in the loop followed by sharing of data with the downstream systems comprising foundational models and other artificial intelligence or data processing systems includes storing information shared in the plurality of modules comprising decision made by the human in the loop followed by sharing of data with the downstream systems comprising foundational models and other artificial intelligence or data processing systems by a recording module.

The method 300 further includes displaying the output or recommendation, or generation received from the corresponding systems to the user, who requested the prompt, after mitigating any attack signatures in step 390. In one embodiment, displaying the output or recommendation, or generation received from the corresponding systems to the user, who requested the prompt, after mitigating any attack signatures includes displaying the output or recommendation, or generation received from the corresponding systems to the user, who requested the prompt, after mitigating any attack signatures by a response display module.

Various embodiments of the system and method to treat identified security risk to artificial intelligence platform described above enable various advantages. The context based risk treatment selection module is capable of identifying the risks associated with an input prompt and classifying the input prompt into multiple risk categories to decide whether to modify the input prompt or block the input prompt, thereby supporting risk mitigation. The synthetic data based sensitive attribute modification module is capable of replacing identified sensitive attributes and sections of the prompt identified as potential adversarial artificial intelligence attack with the synthetic prompt portion, thereby mitigating the adversarial attack risks. The generative artificial intelligence based input data optimization module is configured to create the new prompt without the attack signatures, thereby preserving the context and the structure of the input prompt.

Further, the treatment visualization module is capable of helping the user to visualize the adversarial attack mitigation through blocking or regeneration of the prompt or input data, thereby providing in depth insights to the user regarding the mitigation strategies. The human in loop validation module is capable of receiving an informed consent from the user in case the user is overruling the risk, thereby ensuring transparency and accountability. Combination of the residual risk acceptance module, the consent capture module, and the recording module is also ensuring transparency and accountability of the user's action by validating the identified adversarial attack, by capturing consent of the user, by recording the decision made by the user respectively. Also the response display is capable of displaying the output, thereby assisting the user to visualize the output provided by the AI platform in response to the input prompt.

It will be understood by those skilled in the art that the foregoing general description and the following detailed description are exemplary and explanatory of the disclosure and are not intended to be restrictive thereof. While specific language has been used to describe the disclosure, any limitations arising on account of the same are not intended.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all the acts need to be necessarily performed. Also, those acts that are not dependent on other acts may be performed in parallel with the other acts. The scope of embodiments is by no means limited by these specific examples.

We claim:

1. A system to treat identified security risk to artificial intelligence platform comprising:
characterized in that:
at least one processor in communication with a client processor;
at least one memory comprises a set of program instructions in the form of a processing subsystem, configured to be executed by the at least one processor, wherein the processing subsystem is hosted on a server and configured to execute on a network to control bidirectional communications among a plurality of modules comprising:
a context based risk treatment selection module, operatively coupled to the risk evaluation module, wherein the context based risk treatment selection module is configured to choose treatment based on potential adversarial attack patterns identified in an input prompt or data flow in a generative artificial intelligence ecosystem, based on enterprise policy;
a synthetic data based sensitive attribute modification module, operatively coupled to the context based risk treatment selection module, wherein the synthetic data based sensitive attribute modification module is configured to replace identified sensitive attributes and sections of the prompt identified as potential adversarial artificial intelligence attack with a synthetic prompt portion replaced with a non-attack context based synthetic prompt portion;
a generative artificial intelligence-based input data optimization module, operatively coupled to the synthetic data based sensitive attribute modification module, wherein the generative artificial intelligence based input data optimization module is configured to create a new prompt comprising original input without the attack signature portions and the synthetic portion of the prompt mitigating the identified adversarial attack risk;
a treatment visualization module, operatively coupled to the context based treatment selection module and the generative artificial intelligence based input data optimization module, wherein the treatment visualization module is configured to help user visualize the adversarial attack mitigation through blocking or regeneration of the prompt or input data;
a human in loop validation module, operatively coupled to the treatment visualization module, wherein the human in loop validation module is configured to enable a user to understand the potentially adversarial risk present in the submitted input data or prompt or a series of prompts, wherein the input from human input is taken as an informed consent and overruling of the risk, based on policy configuration of the artificial intelligence ecosystem;
a residual risk acceptance module, operatively coupled to the human in loop validation module, wherein the residual risk acceptance module is configured to enable validation of the identified adversarial attack and corresponding mitigation by a human and incase of risk and corresponding mitigation being acceptable, allowing flowing of the mitigated prompt or data as acceptable residual risk;
a consent capture module, operatively coupled to the residual risk acceptance module, wherein the consent capture module is configured to enable organizations to capture the informed consent of the appropriate user as per the policies for audit and other purposes;
a recording module, operatively coupled to the residual risk acceptance module, wherein the recording module is configured to store information shared in the plurality of modules comprising decision made by the human in the loop followed by sharing of data with the downstream systems comprising foundational models and other artificial intelligence or data processing systems; and
a response display module, operatively connected to internal or external downstream systems comprising foundational models and other artificial intelligence or data processing system, wherein the response display module is configured to display the output or recommendation, or generation received from the corresponding systems to the user, who requested the prompt, after mitigating any attack signatures.

2. The system as claimed in claim 1, wherein the plurality of natural language processing techniques comprises at least one of tokenization, parts of speech tagging, named entity recognition, syntactic parsing, semantic role labeling, word embedding, contextual embedding and conference resolution.

3. The system as claimed in claim 1, wherein the context based risk treatment selection module is configured to identify or classify the input prompt into one or more risk classes comprising white box attack, black box attack, jail break attack, evasion attack, multi stage attack comprising financial risk, health risk, privacy risk, based on the identified attack signatures entity's attributes present into the input prompt and context of the input prompt.

4. The system as claimed in claim 1, wherein the treatment comprises analyzing configuration and learnings from artificial intelligence adversarial attack patterns to block the input prompt.

5. The system as claimed in claim 1, wherein the treatment comprises analyzing configuration and learnings from artificial intelligence adversarial attack patterns to synthetically modify the input prompt.

6. The system as claimed in claim 1, wherein the generative artificial intelligence-based input data optimization module is configured to confirm if the synthetic prompt so created, is no more getting identified as an attack by the risk evaluation module.

7. The system as claimed in claim 1, wherein the generative artificial intelligence based input data optimization module configured to suggest one or more alternatives corresponding to each of the one or prompts to modify the one or more prompts using a generative artificial intelligence platform.

8. The system as claimed in claim 1, wherein the human in loop validation module is configured to enable the user to select at least one option comprising accept the one or more modifications performed by the treatment selection module and reject the one or more modifications performed by the treatment selection module upon receiving the one or more inputs from the user.

9. The system as claimed in claim 1, wherein the recording module configured to record at least one option selected by the user by providing one or more inputs to a validation module for documenting the at least one option selected by the user.

10. The system as claimed in claim 1, wherein the one or more modifications comprises at least one of an addition, deletion, and alteration.

11. The system as claimed in claim 1, wherein the adversarial attack on AI may comprise one or more attack vectors as part of the prompt to cause harm to people or system.

12. A method comprising:
choosing, by a context based risk treatment selection module, by treatment based on potential adversarial attack patterns identified in an input prompt or data flow in a generative artificial intelligence ecosystem, based on enterprise policy;
replacing, by a synthetic data based sensitive attribute modification module, identified sensitive attributes and sections of the prompt identified as potential adversarial artificial intelligence attack with a synthetic prompt portion replaced with a non-attack context based synthetic prompt portion;
creating, by a generative artificial intelligence-based input data optimization module, a new prompt comprising original input without the attack signature portions and the synthetic portion of the prompt mitigating the identified adversarial attack risk;
helping, by a treatment visualization module, user to visualize the adversarial attack mitigation through blocking or regeneration of the prompt or input data;
enabling, by a human in loop validation module, a user to understand the potentially adversarial risk present in the submitted input data or prompt or a series of prompts, wherein the input from human input is taken as an informed consent and overruling of the risk, based on policy configuration of the artificial intelligence ecosystem;
enabling, by a residual risk acceptance module, validation of the identified adversarial attack and corresponding mitigation by a human and incase of risk and corresponding mitigation being acceptable, allowing flowing of the mitigated prompt or data as acceptable residual risk;
enabling, by a consent capture module, organizations to capture the informed consent of the appropriate user as per the policies for audit and other purposes;
storing, by a recording module, information shared in the plurality of modules comprising decision made by the human in the loop followed by sharing of data with the downstream systems comprising foundational models and other artificial intelligence or data processing systems; and
displaying, by a response display module, the output or recommendation, or generation received from the corresponding systems to the user, who requested the prompt, after mitigating any attack signatures.
